(19) United States
(12) Patent Application Publication
(10) Pub. No.: US 2024/0225947 A1
(43) Pub. Date: Jul. 11, 2024

(54) APPARATUS AND METHOD FOR PASSIVELY REMOVING INTERSTITIAL FLUID IN A USERS SCALP

(71) Applicant: MJD INNOVATIONS, LLC, Scappoose, OR (US)

(72) Inventor: Michael R. Dennis, Battle Ground, WA (US)

(73) Assignee: MJD INNOVATIONS, LLC, Scappoose, OR (US)

(21) Appl. No.: 18/410,337

(22) Filed: Jan. 11, 2024

Related U.S. Application Data
(60) Provisional application No. 63/438,471, filed on Jan. 11, 2023.

(51) Int. Cl. A61H 7/00

(52) U.S. Cl. CPC A61H 7/006; A61H 7/001; A61H 2201/0107; A61H 2201/0157; A61H 2201/1253; A61H 2201/1607; A61H 2201/165; A61H 2201/168; A61H 2201/1685; A61H 2201/169; A61H 2201/5071; A61H 2205/021

(57) ABSTRACT

A cap that applies pressure to the scalp to expel inflammatory fluid from the periosteum. In some implementations, the device may include a cap body, having an exterior surface and an interior surface, where the cap body is configured to fit over the head of the user snugly, a chin strap is attached to the cap body, and a plurality of pressure pads secured to the interior surface of the cap body. The pressure pads may be filled with a non-Newtonian material. The user sets the pressure applied by tightening or loosening the chin strap.

### CROSS REFERENCE TO RELATED APPLICATIONS

This application claims priority to copending U.S. Provisional Application, Ser. No. 63/438,471 filed on Jan. 11, 2023, which is hereby incorporated by reference for all purposes.

### BACKGROUND OF THE INVENTION

Fluid accumulates in interstitial spaces between a person's scalp and skull. The scalp includes the skin that covers the person's head. The skull is a framework of bone and/or cartilage enclosing the person's brain. The scalp consists of five layers: skin, connective tissue, galena aponeurotica, loose areolar tissue, and periosteum. The periosteum is a membrane of blood vessels and nerves that wrap around the skull. Blood vessels pass through the bone of the skull to connect with the blood vessels of the periosteum.

In some people, migraines or tension-type headaches may be triggered by and/or may be associated with an inflammation of the tissue layers of the scalp and, in particular, inflammation of the periosteum. Such people have described their experience as an imploding headache (see “Extracranial Origin Of Headache, R. Burstein, et al., PMC6051727, Curr Opin Neurol. 2017, June: 30(3): 263-271, incorporated herein by reference in its entirety). Referred to as pressure pain (pericrania tenderness), tolerance to pressure pain varies among individuals.

Palpation (application of pressure, typically a gentle application of pressure using the fingers in a massaging manner) may relieve such pressure pain in a person's scalp. Here, the palpation relieves the inflammation in the periosteum by encouraging the expulsion of inflammatory fluids in the periosteum that has caused the pressure pain. Such palpation is known to relieve, or even eliminate, migraines and/or tension-type headaches.

Accordingly, in the arts of pain management, there is a need for improved methods, apparatus, and systems for relieving pressure pain in a person's scalp to mitigate and/or eliminate migraines and/or tension-type headaches.

### SUMMARY OF THE INVENTION

Embodiments of the pressure-releasing cap provide a system and method for reducing inflammatory pressure in a user's scalp using a plurality of non-Newtonian material-filled pressure pads residing in a cap or similar that is worn by the user. The non-Newtonian material-filled pressure pads, when held in place by the cap, apply controlled pressure to the user's scalp. The non-Newtonian material-filled pressure pads apply a controlled pressure that is sufficient to expel inflammatory fluids from the scalp yet applies a pressure that is less than the vascular closure pressure.

### BRIEF DESCRIPTION OF THE DRAWINGS

The components in the drawings are not necessarily to scale relative to each other. Like reference, numerals designate corresponding parts throughout the several views.

FIG. 1 is a perspective view of an example embodiment of a scalp pressure cap.

FIG. 2 is a side view of an example embodiment of the scalp pressure cap.

FIG. 3 is a top view of an example embodiment of the scalp pressure cap.

FIG. 4 is a front view of an example embodiment of the scalp pressure cap.

FIG. 5 is a cutaway side of an example embodiment of the scalp pressure cap.

FIG. 6 is a bottom interior view (looking upward) of the scalp pressure cap illustrating example locations of a securing member affixed to the inside surface of the scalp pressure cap.

FIG. 7 is a cutaway interior view of the scalp pressure cap illustrating example locations of a securing member affixed to the inside surface of the scalp pressure cap.

FIG. 8 is a cutaway interior view of the scalp pressure cap illustrating example locations of a securing member affixed to the inside surface of the scalp pressure cap.

### DETAILED DESCRIPTION

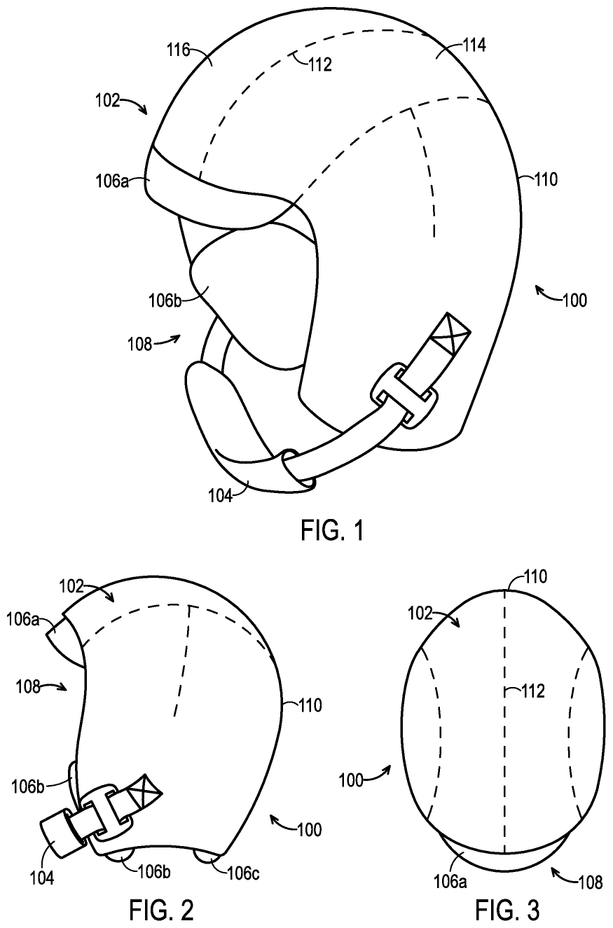

FIG. 1 is a perspective view of an example embodiment of a scalp pressure cap 100. Embodiments of the scalp pressure cap 100 comprise a cap body 102, an optional adjustable chin strap 104, and a plurality of pressure pads 106. The plurality of pressure pads 106 are filled with a non-Newtonian material. The non-Newtonian material-filled pressure pads 106, when held in place by the cap body 102, apply controlled pressure to the user's scalp. The controlled pressure exerted by the non-Newtonian material-filled pressure pads 106 is sufficient to expel inflammatory fluids (interchangeably referred to herein as lymphatic fluid) from the scalp. However, the applied pressure is less than the vascular closure pressure that would otherwise close the veins in the user's scalp tissue.

The disclosed systems and methods for a scalp pressure cap 100 will become better understood through a review of the following detailed description in conjunction with the figures. The detailed description and figures provide examples of the various inventions described herein. Those skilled in the art will understand that the disclosed examples may be varied, modified, and altered without departing from the scope of the inventions described herein. Many variations are contemplated for different applications and design considerations. However, for the sake of brevity, each and every contemplated variation is not individually described in the following detailed description.

Throughout the following detailed description, a variety of examples of systems and methods for a scalp pressure cap 100 are provided. Related features in the examples may be identical, similar, or dissimilar in different examples. For the sake of brevity, related features will not be redundantly explained in each example. Instead, the use of related feature names will cue the reader that the feature with a related feature name may be similar to the related feature in an example explained previously. Features specific to a given example will be described in that particular example. The reader should understand that a given feature need not be the same or similar to the specific portrayal of a related feature in any given figure or example.

The following definitions apply herein unless otherwise indicated.

“Substantially” means to be more-or-less conforming to the particular dimension, range, shape, concept, or other aspect modified by the term, such that a feature or component need not conform exactly. For example, a “substantially cylindrical” object means that the object resembles a cylinder but may have one or more deviations from a true cylinder.

“Comprising,” “including,” and “having” (and conjugations thereof) are used interchangeably to mean including but not necessarily limited to and are open-ended terms not intended to exclude additional elements or method steps not expressly recited.

Terms such as “first,” “second,” and “third” are used to distinguish or identify various members of a group or the like and are not intended to denote a serial, chronological, or numerical limitation.

“Coupled” means connected, either permanently or releasably, whether directly or indirectly through intervening components. “Secured to” means directly connected without intervening components.

“Communicatively coupled” means that an electronic device exchanges information with another electronic device, either wirelessly or with a wire-based connector, whether directly or indirectly, through a communication network. For example, a pressure sensor may detect pressure and communicate pressure information to a processing system. “Controllably coupled” means that an electronic device controls the operation of another electronic device.

Returning to FIG. 1, a user wearing the scalp pressure cap 100 experiences a pain relieving pressure applied to their scalp by the plurality of pressure pads 106. Embodiments of the scalp pressure cap 100 comprise a cap body 102, an optional adjustable chin strap 104, and a plurality of pressure pads 106. Pressure pads 106 are generically represented using reference numeral 106, with specific pressure pads identified using reference numerals 106i. For example, pressure pad 106a is one of the plurality of pressure pads 106 that is located on the inside top surface of the cap body 102. The pressure pad 106b is located on the inside right side of the cap body 102. The cap body 102 is defined, in part, by an open front 108, a rear edge 110, and a lateral line 112 separating the cap 102 into a left half 114 and a right half 116.

FIG. 2 is a side view of an example embodiment of the scalp pressure cap 100. For illustrative purposes, lower portions of the lower pressure pads 106b and 106c are visible.

FIG. 3 is a top view of an example embodiment of the scalp pressure cap 100. Preferably, the cap body 102 is made of a soft, flexible fabric material that is comfortable to the user when wearing the scalp pressure cap 100. In other embodiments, the cap body 102 may be made of a rigid material or semi-rigid material, such as fabric, plastic, or metal.

The scalp pressure cap 100 is sized to fit around the head of the user. In an example embodiment, the size of the user's head is initially measured. Then, based on the measured head size of the user, the corresponding size dimensions of the cap body 102 may be determined based on cap fitting data that has been previously defined for other individuals having known head dimensions. The cap body 102 provides an interior space sufficient to snugly hold the user's head and the plurality of pressure pads 106.

When the scalp pressure cap 100 is worn by the user, the plurality of pressure pads 106 apply a predefined amount of pressure, or range of pressures, to the user's scalp. Preferably, pressure is applied evenly around the scalp of the user. In some embodiments, the location of particular ones of the pressure pads 106 may be predefined to provide specific pressure to a particular targeted location on the user's scalp.

The pressure applied to the user's scalp is between 1.4 (0.2 psi) and 4.3 kPa (0.62 psi). A pressure greater than 1.4 kPa is sufficient to expel, or at least partially expel, inflammation-type fluids in the user's scalp. In particular, the scalp pressure cap 100 is configured to expel inflammatory fluids present in the periosteum, which is a membrane of blood vessels and nerves that wraps around the skull. Such inflammatory fluids are associated with migraines and/or tension-type headaches.

However, the pressure applied by any one of the pressure pads 106 is less than 4.3 kPa (0.62 psi). A pressure of 4.3 kPa or greater is known to cause the collapse of blood vessels. This 4.3 kPa (0.62 psi) pressure is referred to herein as the vascular closure pressure. Accordingly, by applying a pressure of less than 4.3 kPa (0.62 psi), the blood vessels in the periosteum remain open so that the inflammatory fluids can be expelled from the user's scalp.

In various embodiments, pressure pads 106 are fabric or soft plastic pads that contain a non-Newtonian material. A non-Newtonian material (interchangeably referred to herein as a non-Newtonian fluid) does not follow Newton's law of viscosity, which states that a material has a constant viscosity independent of the amount of applied stress. In a non-Newtonian material, the viscosity of the material changes depending on the amount of applied stress (pressure). The non-Newtonian material in pressure pad 106 is selected so that the material viscosity remains relatively low and constant up to an applied predefined viscosity threshold pressure. The predefined viscosity threshold pressure is preferably less than the vascular closure pressure of 4.3 kPa (0.62 psi). When the applied pressure is less than the predefined viscosity threshold, the non-Newtonian material remains as a relatively stable solid, foam-like, or gel-like material that does not substantially deform or compress when pressure is applied, such as when the user is wearing the scalp pressure cap 100.

That is, when the scalp pressure cap 100 is worn by the user, the plurality of pressure pads 106 apply localized pressure to the scalp. Each pressure pad 106 is pressed onto a portion of the user's scalp by the snugly fitting cap body 102. The force applied by the cap body 102 onto one side of the pressure pad 106 is transferred to the opposing side of the pressure pad 106 that is in contact with a portion of the user's scalp.

If the pressure applied by the cap body 102 on any particular one of the pressure pads 106, or a portion of the pressure pad 106, exceeds a predefined viscosity threshold, then the viscosity of the non-Newtonian material decreases so that the non-Newtonian material deforms to flow away from the higher pressure region (that exceeds the predefined viscosity threshold). In a preferred embodiment, the non-Newtonian material has a flat deformation rebound curve and will not exceed the vascular closure pressure of 4.3 kPa (0.62 psi) until the non-Newtonian material is compressed to 70% of its thickness.

As the lower viscosity non-Newtonian material flows away from the high-pressure region, pressure in that region of the user's scalp decreases. When the pressure decreases to below the predefined viscosity threshold (on decreases to a recovery viscosity threshold), the viscosity returns to the non-Newtonian material such that the flow of the non-Newtonian material ceases. That is, when the applied pressure on the user's scalp exceeds the predefined viscosity threshold, the non-Newtonian material viscosity decreases so as to allow the non-Newtonian material to flow away from the high-pressure area, thereby reducing the applied pressure to the user's scalp. Since the predefined viscosity threshold is less than the 4.3 kPa (0.62 psi) pressure that is known to collapse blood vessels, the blood vessels in the user's scalp remain open to permit the expulsion of inflammatory fluids. (If a material that fills the pressure pads is a Newtonian type material or another material that does not deform to relieve pressure that exceeds 4.3 kPa (0.62 psi), then the blood vessels in the user's scalp will collapse such that the inflammatory fluids cannot be expelled from the user's scalp.)

Any suitable non-Newtonian material-filled pressure pads 106, now known or later developed, may be used in the various embodiments. The selected non-Newtonian material may have any suitable predefined viscosity threshold that is less than 4.3 kPa (0.62 psi) to prevent blood vessel collapse, and the selected non-Newtonian material preferably retains its state (does not substantially deform) when the applied pressure is greater than 1.4 kPa (0.2 psi).

One skilled in the art appreciates that some amount of material deformation is likely to occur when pressure is applied by the scalp pressure cap 100 and the user's scalp. So long as the amount of pressure applied exceeds 1.4 kPa (0.2 psi), even after some amount of material deformation, then the inflammatory fluids will be expelled from the user's scalp by the pressure pad 106.

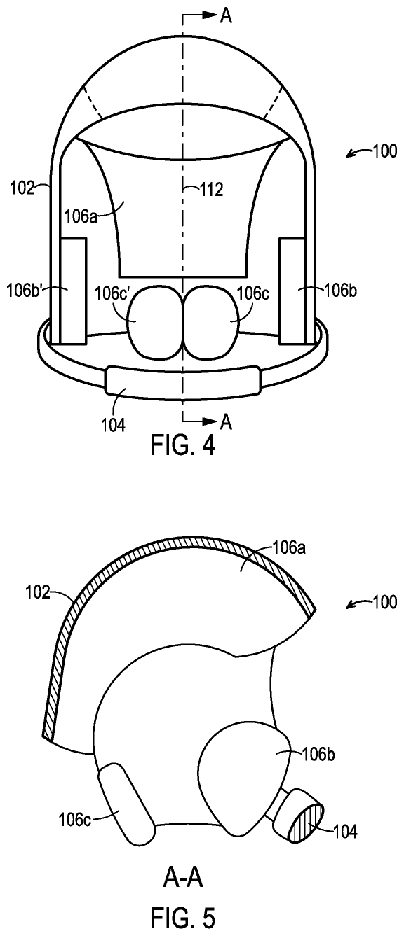

FIG. 4 is a front view of a non-limiting example embodiment of the scalp pressure cap 100. FIG. 5 is a cutaway side of the example embodiment of the scalp pressure cap 100. In this example embodiment, the pressure pad 106a fits over the top of and over a rear portion of the user's scalp. The pressure pads 106b, 106b′ are located along the sides of the user's scalp. The pressure pads 106c, 106c′ are located at the lower rear of the user's scalp near the user's neck.

Any number of pressure pads 106 at selected (predefined) locations may be used in the various embodiments of the cap body 102. The pressure pads 106 may have any suitable dimension (length, width, thickness, etc.). The pressure pads 106 may have any suitable shape, such as, but not limited to, a disk, an oval, a rectangle, a polygon, or other designed shapes. For example, the pressure pad 106a may comprise a plurality of smaller pressure pads 106. As another example, the two pressure pads, 106c and 106c′, may be replaced with a single pressure pad 106. The pressure pads 106b and 106b′ may have different dimensions depending upon the user's preferences. For example, inflammation of the scalp may be different at different scalp locations. Accordingly, the location and/or dimension of a selected pressure pad 106 may be defined so as to apply a desired pressure at a particular scalp location of interest.

The pressure pads 106 may have any suitable thickness. The selected thickness defines, in part, the amount of applied pressure to the region of the user's scalp that is in contact with that particular pressure pad 106. For example, a particular portion of the user's scalp at a location of interest may not be receiving a sufficient amount of pressure to expel the inflammatory fluids in that portion of the scalp that is receiving pressure from that particular pressure pad 106. The pressure pad 106 may be removed and replaced using a thicker pressure pad 106. The thicker pressure pad 106 will apply a greater amount of pressure at the location of interest on the user's scalp.

In a preferred embodiment, the plurality of pressure pads 106 are secured to the interior surface of the cap body 102 using a hook and loop fastener. In practice, once a particular cap body 102 is selected for the user based on the dimensions of the user's head, the pressure pads 106 may be selected and secured to the interior surface of the cap body 102. If any particular one or more of the pressure pads 106 is not applying a desired amount of pressure to the user's scalp, that particular pressure pad 106 may be removed and replaced with a different pressure pad 106 that does apply a desired amount of pressure. For example, if the applied pressure is not sufficient, then a thicker pressure pad 106 may replace the current pressure pad 106. Conversely, if too much pressure is applied by a particular pressure pad 106, that pressure pad 106 may be replaced by a thinner pressure pad 106. The hook and loop material, sewn into the interior surface of the cap body 102 and onto an outside surface of the pressure pad 106, facilitates securing and/or removal of a pressure pad 106.

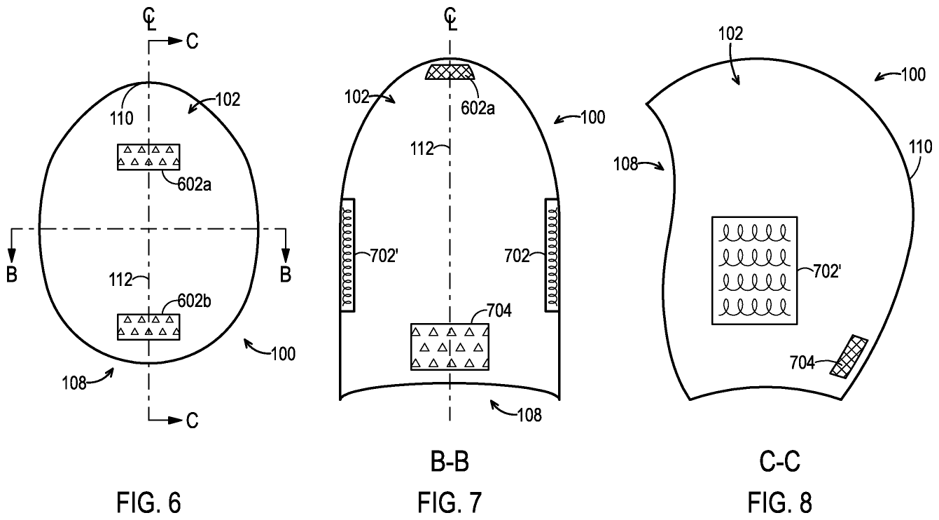

FIG. 6 is a bottom interior view (looking upward) of the scalp pressure cap 102, illustrating example locations of securing members 602a and 602b affixed to the inside surface of the scalp pressure cap 102. The securing members 602a and 602b are made of the hook side or the loop side of a hook and loop fastener. The corresponding portion of the hook and loop fastener is secured to a surface of the pressure pad 106a such that the pressure pad 106a that covers the top portion of the user's scalp can be releasably secured to the interior surface of the cap body 102.

FIG. 7 is a cutaway interior view of the scalp pressure cap 102 illustrating example locations of securing members 702, 702′, and 704 affixed to the inside surface of the scalp pressure cap 102. The securing members 702, 702′, and 704 are made of the hook side or the loop side of a hook and loop fastener. Here, the securing member 702 is configured to secure the pressure pad 106b (FIG. 4). The securing member 702′ is configured to secure the pressure pad 106b′. The securing member 704 is configured to secure the pressure pads 106c and/or 106c′.

FIG. 8 is a cutaway interior view of the scalp pressure cap 102 illustrating the example location of the securing members 702 and 704 affixed to the inside surface of the scalp pressure cap 102.

Any suitable securing means may be used to secure the pressure pads 106 onto the interior surface of the cap body 102. Securing means may include magnets, an adhesive, a releasable adhesive, buttons, snaps, pockets, pins, or thread (sewing or tying). Different securing means may be used for different pressure pads 106. In some embodiments, one or more of the pressure pads 106 may be an integrated member of the structure of the cap body 102 (sewn to or disposed within).

In a preferred embodiment, an adjustable chin strap 104 may be used to adjust tightness (pressure) provided by the scalp pressure cap 100. The user may adjust the tightness of the chin strap 104 to provide the desired pressure by the scalp pressure cap 100. In some embodiments, the chin strap 104 may not be adjustable. In other embodiments, the chin strap 104 may be omitted or may be removable.

In some embodiments, optional pressure sensors may be used to monitor pressure that is applied to the user's scalp by a particular one of the pressure pads 106.

It should be emphasized that the above-described embodiments of the scalp pressure cap 100 are merely possible examples of implementations of the invention. Many variations and modifications may be made to the above-described embodiments. All such modifications and variations are intended to be included herein within the scope of this disclosure and protected by any later filed claims.

Furthermore, the disclosure above encompasses multiple distinct inventions with independent utility. While each of these inventions has been disclosed in a particular form, the specific embodiments disclosed and illustrated above are not to be considered in a limiting sense as numerous variations are possible. The subject matter of the inventions includes all novel and non-obvious combinations and sub-combinations of the various elements, features, functions, and/or properties disclosed above and inherent to those skilled in the art pertaining to such inventions. Where the disclosure or subsequently filed claims recite “a” element, “a first” element, or any such equivalent term, the disclosure or claims should be understood to incorporate one or more such elements, neither requiring nor excluding two or more such elements.

Applicant(s) reserves the right to submit claims directed to combinations and subcombinations of the disclosed inventions that are believed to be novel and non-obvious. Inventions embodied in other combinations and sub-combinations of features, functions, elements, and/or properties may be claimed through amendment of those claims or presentation of new claims in the present application or in a related application. Such amended or new claims, whether they are directed to the same invention or a different invention and whether they are different, broader, narrower, or equal in scope to the original claims, are to be considered within the subject matter of the inventions described herein.

1. A scalp pressure cap comprising: a cap body, having an exterior surface and an interior surface, providing a user having a scalp requiring treatment, where the cap body is configured to snugly fit over the head of the user, and a chin strap attached to the cap body, and a plurality of pressure pads secured to the interior surface of the cap body: wherein the pressure pad further comprises a non-Newtonian material; and the pressure pads apply pressure to the user's scalp.

2. The scalp pressure cap of claim 1, where the chin strap is tightened or loosened to increase or decrease the amount of pressure applied to the user's scalp.

3. The scalp pressure cap of claim 2, where the pressure applied evenly over the user's scalp.

4. The scalp pressure cap of claim 3, where the pressure applied is sufficient to expel inflammatory fluids from the user's scalp but less than the vascular closure pressure.

5. The scalp pressure cap of claim 4, where the pressure applied is between 1.4 to 4.3 kPa.

6. The scalp pressure cap of claim 5, where the pressure pads further include sensors to measure the pressure applied to the user's scalp.

7. A scalp pressure cap comprising: a cap body having an interior surface and an exterior surface, providing a user with a scalp requiring treatment, where the cap body is configured to snugly fit over the head of the user, and a chin strap, and a plurality of pressure pads are deposited on the interior surface of the cap body: wherein the pressure pad further comprises a non-Newtonian material; and the pressure pads apply pressure to the user's scalp.

8. The scalp pressure cap of claim 7, where the cap body is made from a soft flexible material, where the soft flexible material comprises a fabric or a semi-rigid material.

9. The scalp pressure cap of claim 8, where pressure pads are removably attached to the interior surface of the cap body.

10. The scalp pressure cap of claim 9 where the removable attachment further comprises a hook and loop system, or snaps, or buttons, or a releasable adhesive.

11. The scalp pressure cap of claim 9, where the chin strap is tightened or loosened to increase or decrease the amount of pressure applied to the user's scalp.

12. The scalp pressure cap of claim 11, where the pressure is applied evenly over the user's scalp or unevenly over the user's scalp.

13. The scalp pressure cap of claim 12, where the pressure applied is sufficient to expel inflammatory fluids from the user's scalp but less than the vascular closure pressure.

14. The scalp pressure cap of claim 12, where the pressure applied is between 1.4 to 4.3 kPa.

15. The scalp pressure cap of claim 14, where the pressure pads further include sensors to measure the pressure applied to the user's scalp.

16. A method for expelling inflammatory fluids from the user's scalp comprising: the user donning the scalp pressure cap of claim 7 and adjusting the pressure by tightening or loosening the chin strap.

17. The method of claim 16 where the pressure applied is sufficient to expel the inflammatory fluids from the user's scalp but is less than the vascular closure pressure.

18. The method claim 16 where the pressure applied is between 1.4 to 4.3 kPa.
